(19) United States
(12) Patent Application Publication
(10) Pub. No.: US 2013/0312196 A1
(43) Pub. Date: Nov. 28, 2013

(54) NURSING PILLOW SET AND METHODS OF CONSTRUCTION AND USE

(71) Applicant: Danielle Alicia Jenkins, San Jose, CA (US)

(72) Inventor: Danielle Alicia Jenkins, San Jose, CA (US)

(21) Appl. No.: 13/870,957

(22) Filed: Apr. 25, 2013

Related U.S. Application Data
(60) Provisional application No. 61/687,434, filed on Apr. 25, 2012.

(51) Int. Cl. A47D 13/08; B68G 7/12; B68G 7/06

(52) U.S. Cl. CPC A47D 13/083; B68G 7/06; B68G 7/12
USPC 5/655; 29/91.1

(57) ABSTRACT

A pillow system set comprises a curved, U-shaped main pillow. The main pillow is both flexible and firm to permit it to wrap around a user while nursing an infant. A separate companion pillow is included in the pillow system set. In one embodiment the companion pillow is round or circular. The companion pillow may be used in 1 of 2 ways: 1) to place within a user's hip, when seated, under the main pillow, to prop up one side of the main pillow when wrapped around a user's waist during feeding, and 2) as a toy for an infant. Some embodiments of the companion pillow may contain a rattle enclosed within an interior compartment of the pillow. An additional piece to the pillow system set is a flat, rectangular fabric or protective towel to serve dual-use: 1) to act as a protectant to the main pillow, preventing soils from penetrating the main pillow, and 2) as a burp cloth to lay over a user's shoulder while burping an infant.

### CROSS-REFERENCE TO RELATED APPLICATIONS

This patent application claims priority under 35 U.S.C. §119(e) to U.S. Provisional Patent Application Ser. No. 61/687,434 filed Apr. 25, 2012, The disclosure of U.S. Provisional Patent Application Ser. No. 61/687,434 is hereby incorporated by reference in its entirety.

### TECHNICAL FIELD

The disclosed invention relates to a nursing pillow set for use by an infant care provider in the feeding of a nursing infant.

### SUMMARY OF THE INVENTION

Embodiments of the disclosed invention relate to a nursing pillow set for use by an infant care provider in feeding a nursing infant, and further provide methods for making the nursing pillow set, and methods for using the nursing pillow set. An infant care provider may be any responsible and qualified adult, such as a parent or a person acting in the capacity of an infant care provider. Feeding an infant may occur by way of bottle-feeding, or in the case of a lactating woman acting as the infant care provider, by way of breast-feeding. In typical embodiments of the method, an infant is being fed milk, but feeding may refer to providing an infant formula or any liquid appropriate for consumption by an infant.

The function of the nursing pillow set is to facilitate the feeding of an infant by an rut nit care provider, at least in part by stabilizing avid supporting the body positions assumed by the infant and infant care provider, respectively, during feeding of the infant. Such bodily support is further provided in a manner that is ergonomic, particularly with regard to the infant care provider. Additionally, some elements of the nursing pillow set, may be decorated and formed into a toy-like configuration, and may have toy-related functionality.

Embodiments of the nursing pillow set may include these elements: a generally U-shaped support pillow, a pillow protector, and a small second pillow, which may also be referred to as a companion pillow, a toy pillow, or a round pillow. Some embodiments of the nursing pillow set include only the U-shaped support pillow and the pillow protector; while still other embodiments include only the U-shaped support pillow and the small second pillow. A saleable form of the nursing pillow set may include all three elements packaged together, or two items packaged together, or individual elements ma be packaged and sold separately.

### BRIEF DESCRIPTION OF THE DRAWINGS

FIG. 1 illustrates an embodiment of the nursing pillow set decoratively formed as a baseball and a baseball mitt.

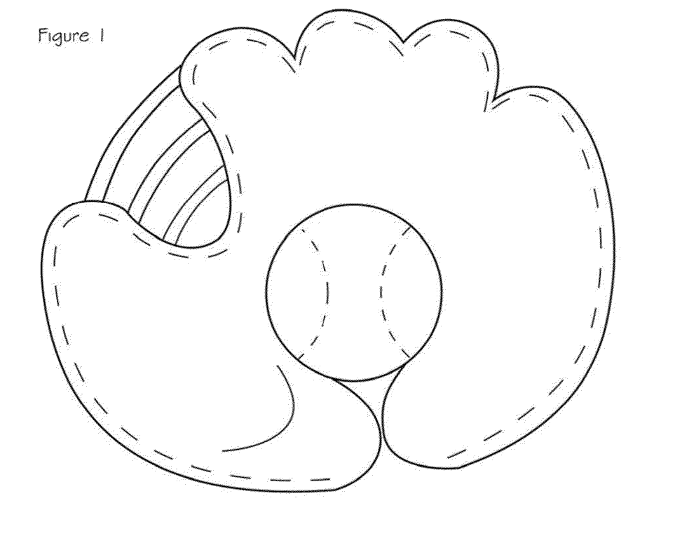

FIG. 2 illustrates the operation of the nursing pillow set in a first mode, wherein the U-shaped support pillow (100) allows a user to support an infant while nursing or playing. The companion pillow (200) is situated beneath the U-shaped support pillow at the site of the user's upper thigh. The companion pillow (200) provides bodily support in a mariner that is ergonomic, particularly with regard to the infant care provider.

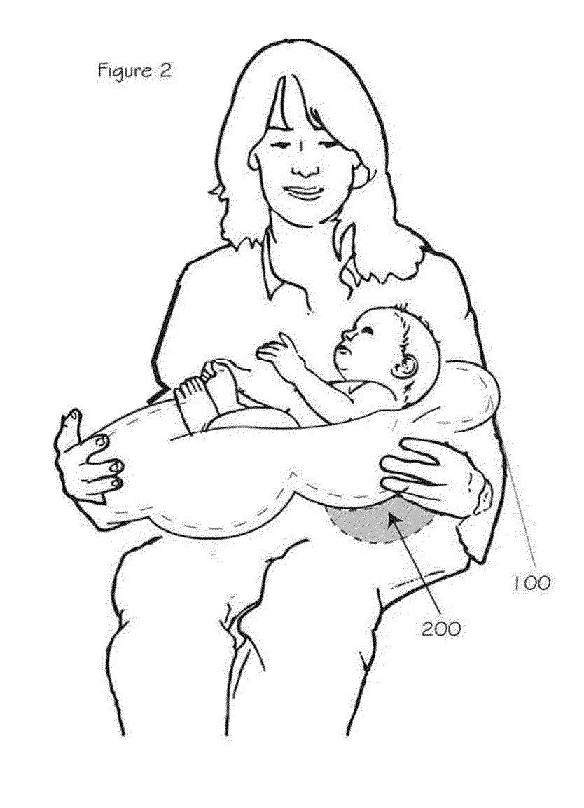

FIG. 3 illustrates the operation a the nursing pillow set in a second mode, wherein the U-shaped support pillow (100) allows a user to support an infant while nursing or playing after feeding. The companion pillow (200) is situated beneath the U-shaped support pillow at the site of the user's hip. The companion pillow (200) elevates the head of the infant to benefit the digestive process and improve the overall comfort of the infant. During feeding, the companion pillow (200) allows the user to create an optimal angle which favors an efficient flow of milk down infant's throat and also minimizes inclusion of air within the liquid stream and the consequent reflux and build up of gas in the stomach and intestinal tract.

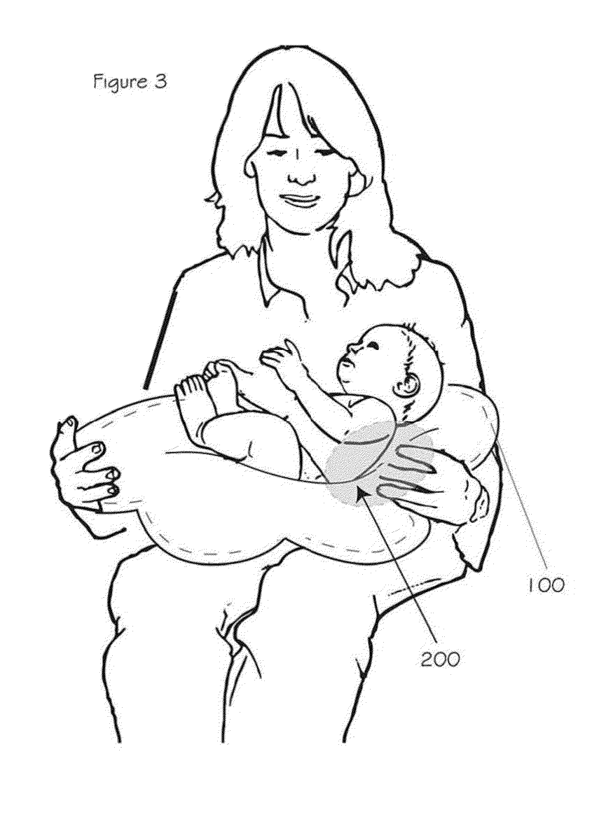

FIG. 4 illustrates an infant engaging with the companion pillow as a toy (300), wherein the companion pillow (300) is in the shape of a baseball and an interior compartment may comprise fill material and a rattle.

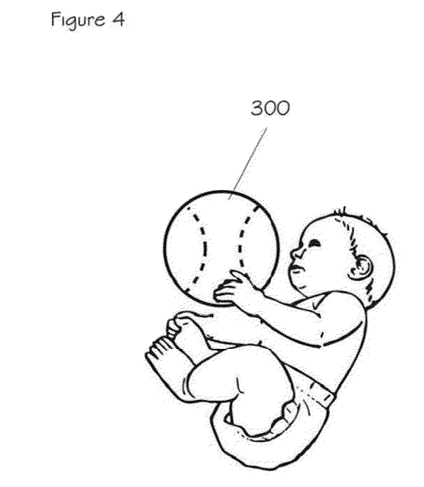

FIG. 5 illustrates one embodiment of the protective towel, which functions to protect the U-shaped support pillow from spots and soils, and act as a burp cloth for the infant care provider to transfer from the U-shaped support pillow to a shoulder, upon which to burp the infant.

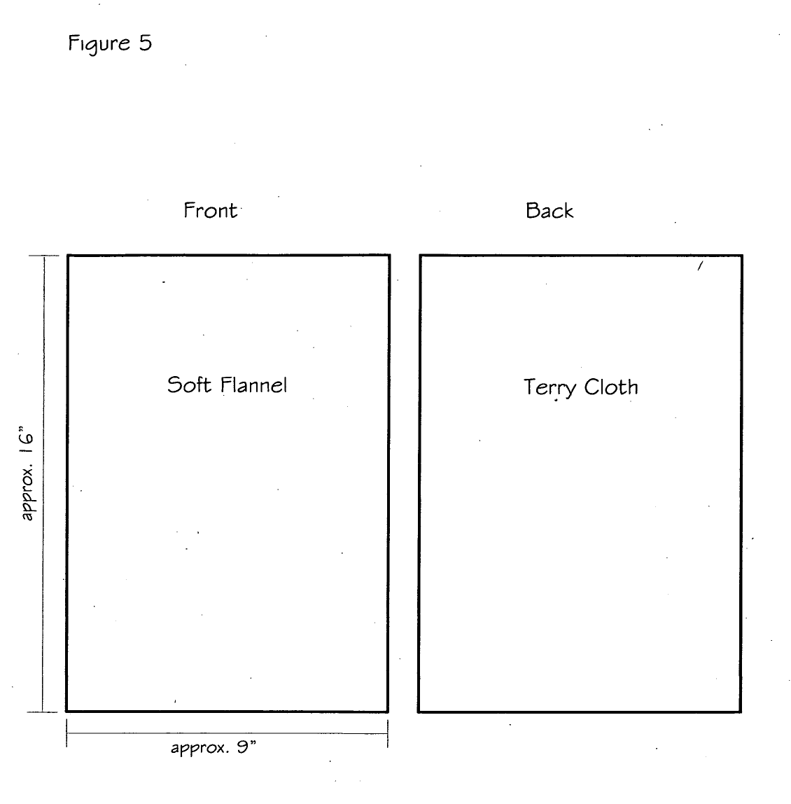

### DETAILED DESCRIPTION

Embodiments of the packaged nursing set provided herein may include the following elements:

Element 1. A generally U-shaped support pillow that may be formed into various decorative shapes that may include, merely by way of example, a flower, a baseball mitt, a frog, a football, or a moon. Embodiments of the U-shaped support pillow may be covered in any fabric suitable and appropriate for infant contact. By way of example, particular embodiments may include a super-soft or flannel-type covering fabric. In a particular embodiment, the U-shaped support pillow has dimensions of approximately 27″×22″×5″.

Element 2. A second element includes a protective towel; in one particular embodiment the towel is a double-layered rectangular fabric portion having dimensions of approximately 9½″×16″. in some embodiments, the fabric is formed from different types of fabric, for example, a first side having a terry cloth aspect and a second side having a flannel aspect. The protective towel has two functions: A) to lay on top of the nursing U-shaped support pillow where the infant nurses, to protect the nursing U-shaped support pillow from spots and soils, and B) act as a burp cloth for the infant care provider to transfer from the U-shaped support pillow to a shoulder, upon which to burp the infant.

Element 3. A third element comprises a small second pillow or companion pillow, one particular embodiment being circular and having dimensions of approximately 8½″ in diameter by approximately 3½″ in height. In some embodiments, the companion pillow is covered in an ultra-soft or a faux-mink type of fabric. Some embodiments of the companion pillow may contain a rattle enclosed within an interior compartment of the pillow. Companion pillow embodiments may include decorative elements, such as: A) a flower's center, with a small flower, a butterfly, a bumblebee, a ladybug that is attached to pillow, but may pull away from pillow by an elastic leash, B) a baseball with rattle inside, or C) a lily pad with a lotus flower attached. Though decorative in nature, these elements lend visual and tactile support to the toy-like function that the companion pillow may provide.

### Process of Making a Nursing Pillow Set

Embodiments of the provided invention include methods of constructing elements of the nursing pillow set.

Steps in constructing a U-shaped pillow may include: Using a U-shaped pattern to two pieces of fabric in a U-shape; pinning pieces together and sewing to form a pillow pocket; turning the pillow pocket right-side out stuffing or placing a pillow insert into the pillow pocket, and hand-sewing or installing a zipper to close and complete the U-shaped pillow construction.

Steps in constructing a pillow protector may include: Measuring and cutting two pieces of rectangular fabric to size, placing back-to-back, then sewing the two pieces together. Further steps include turning: the pillow protector right-side out, ironing it flat, and sewing a decorative edging around the perimeter to complete the construction of the pillow protector.

Steps in constructing a companion pillow may include: Using a circle pattern to cut two pieces of fabric into a circle shape. Further steps include pinning and sowing the two pieces together to form a pillow pocket. Further steps include turning the sewed pieces right-side out, stuffing an insert into the formed pillow pocket, and hand-sewing the pillow pocket closed to complete the companion pillow construction.

### Process of Using a Nursing Pillow Set

Embodiments of the provided invention include methods of using elements of the nursing pillow set to facilitate feeding of an infant, and providing ergonomic support for the infant care provider.

An infant care provider may use an embodiment of the U-shaped support pillow as a nursing support tool. The pillow protector has a dual use, protecting the U-shaped support pillow from soils and stains, and it may be further used as a burp-cloth, by laying the pillow protector over a shoulder while burping infant. Embodiments of the companion pillow may be used as an ergonomic support element either for the care provider or the infant, as well as a to for the infant. By resting the companion pillow underneath the U-shaped support pillow, while in a seated position, an infant care provider can create an optimal feeding angle. Arranging the companion pillow underneath the U-shaped support pillow at the site of the care provider's upper thigh or hip props the infant's head at such at an optimal feeding angle. Such an optimal angle favors an efficient flow of milk down infant's throat and also minimizes inclusion of air within the liquid stream and the consequent reflux and build up of gas in the stomach and intestinal tract.

As a whole, by these various effects, the use of an embodiment of the nursing pillow set benefits the digestive process and the overall comfort of the infant.

1. A nursing pillow set for use by an infant care provider when feeding an infant, the pillow set comprising:
a generally U-shaped infant support pillow;
a protective towel; and
a companion pillow,
wherein the protective towel is sized and adapted both to protect the cleanliness of the U-shaped pillow when disposed thereon, and to serve as burp cloth when placed on the shoulder of the infant care provider while burping the infant, and
wherein the companion pillow is sized and configured to provide ergonomic support for the infant's head and is further functional as a toy in a manner that is related to the U-shaped pillow.

2. The nursing pillow set of claim I wherein the fabric, portions and the U-shaped support pillow are attachable to each other in a manner that is quickly releasable.

3. The nursing pillow set of claim 2 wherein the U-shaped support pillow is in the form of a decorative shape selected from the group consisting of a flower, a baseball mitt, a frog, a football, and a moon.

4. The nursing pillow set of claim 3 wherein the U-shaped support pillow is covered with any fabric that is suitable and appropriate for infant contact.

5. The nursing pillow set of claim 4 wherein the fabric is a super-soft or flannel-type covering fabric.

6. The nursing pillow set of claim 5 wherein the U-shaped support pillow has dimensions of approximately 27″×22″×5″.

7. The nursing pillow set of claim 6 wherein the protective towel is a double-layered rectangular fabric portion having dimensions of approximately 9½″×16″.

8. The nursing pillow set of claim 7 wherein the protective towel is comprised of fabric wherein a first side has a terry cloth aspect and a second side has a flannel aspect.

9. The nursing pillow set of claim 8 wherein the companion pillow is covered in an ultra-soft or a faux-mink type of fabric.

10. The nursing pillow set of claim 9 wherein the companion pillow is circular and has dimensions of approximately 8½″ in diameter by approximately 3½″ in height.

11. The nursing pillow set of claim 10 wherein the companion pillow includes decorative elements, selected from the group consisting of:
a baseball;
a lily pad with a lotus flower attached; and
a flower's center with a small flower, a butterfly, a bumblebee, or a ladybug that is attached to the U-shaped support pillow, but may pull away from the U-shaped support pillow by way of an elastic leash.

12. The nursing pillow set of claim 11 wherein the companion pillow houses an interior compartment containing fill material and a rattle.

13. A method of using the nursing pillow set of claim 2 to facilitate feeding of an infant, and provide ergonomic support to the infant care provider.

14. The method of claim 13 wherein an infant care provider uses the U-shaped support as a nursing support tool.

15. The method of claim 14 wherein the companion pillow is used as an ergonomic support element for the care provider.

16. The method of claim 14 wherein the companion pillow is used as an ergonomic support element either for the infant.

17. The method of claim 13 wherein the companion pillow is used as a toy for the infant.

18. A method of constructing the U-shaped support pillow of the nursing pillow set of claim 2, wherein steps in the method include:
using a U-shaped pattern to cut two pieces of fabric into a U-shape;
pinning and sewing the two pieces together to form a pillow pocket;
turning the pillow pocket right-side out, and stuffing or placing a pillow insert into the pillow pocket, and
hand-sewing or installing a zipper to close and complete the U-shaped support pillow construction.

19. A method of constructing the pillow protector of the nursing pillow set of claim 2, wherein steps in the method include:
measuring and cutting two pieces of rectangular fabric to size,
placing said pieces back-to-hack and sewing the two pieces together,
turning the pillow protector right-side out, ironing it flat, and
sewing a decorative edging around the perimeter to complete the construction of the pillow protector.

20. A method of constructing the companion pillow of the nursing pillow set of claim 2, wherein steps in the method include:
using a circle pattern to cut two pieces of fabric into a circle shape;
pinning and sewing the two pieces together to form a pillow pocket;
turning the pillow pocket right-side out, and stuffing an insert or fill material into the pillow pocket; and
hand-sewing the pillow pocket closed to complete the companion pillow construction.
